(19) United States
(12) Patent Application Publication
(10) Pub. No.: US 2026/0088596 A1
(43) Pub. Date: Mar. 26, 2026

(54) IMPROVEMENTS RELATING TO HANGERS AND HANGER SYSTEMS

(71) Applicant: GRIPPLE LIMITED, Sheffield, South Yorkshire (GB)

(72) Inventor: Thomas Reynolds, Sheffield, South Yorkshire (GB)

(21) Appl. No.: 19/109,468

(22) PCT Filed: Sep. 13, 2023
(86) PCT No.: PCT/IB2023/059067

§ 371 Date: Mar. 6, 2025

(30) Foreign Application Priority Data
Sep. 16, 2022 (GB) 2213598.2
Sep. 13, 2023 (GB) 2313936.3

(51) Int. Cl. H02G 3/04; F16L 3/12

(52) U.S. Cl. CPC H02G 3/0456; F16L 3/12

(57) ABSTRACT

A hanger (10) is disclosed, comprising a main part (12). The main part (12) has a holding formation (36) for holding an elongate article (1B) extending therethrough. The main part (12) comprises a plurality of walls (18, 26, 28, 29, 32, 80) defining at least one support compartment (38A, 38B, 38C, 38D) for supporting an elongate item (1A). A first wall (28) of the plurality of walls (18, 26, 28, 29, 32, 80) comprises a gap (22) to allow elongate items (1A) to be received in a support compartment (38A, 38B, 38C, 38D). A spacer (90) is also disclosed. A closure member (24) is also disclosed. A wire channel (118) and wire form (114) are also disclosed.

### FIELD OF THE INVENTION

Embodiments of the present invention relate to hangers and hanger systems. In particular, but not exclusively they relate to hangers and hanger systems for use in solar farms.

### BACKGROUND TO THE INVENTION

The installation of electrical cables can require cables to be suspended. However, in some circumstances, for example on solar farms, or in other situations, such as on the electricity supply system of an electric railway, it may be difficult finding suitable articles from which the cables can be suspended.

### BRIEF DESCRIPTION OF VARIOUS EMBODIMENTS OF THE INVENTION

According to an aspect of this invention, there is provided a hanger comprising a main part having a holding formation for holding an elongate article extending therethrough, and the main part comprising a plurality of walls defining a support compartment for supporting an elongate item, wherein a first wall of the plurality of walls defines a gap of the hanger to allow the elongate item to be received in the support compartment, the hanger further including a closure member to close the gap, the closure member being movable between an open position in which the gap is open and a closed position to close the gap, and wherein a cross-sectional geometric centroid of the first wall overlaps a cross-section of the closure member.

An advantage is a stiffer hanger. The alignment of the closure member with the neutral axis of the first wall stiffens the hanger regardless of which axis the hanger is flexed or twisted about.

According to a further aspect of this invention, there is provided a hanger comprising a main part having a holding formation for holding an elongate article extending therethrough, and the main part comprising a plurality of walls defining a first support compartment and a second support compartment each for supporting an elongate item, wherein a first wall of the plurality of walls comprises a gap to allow the elongate item to be received in one or any one of the first and second support compartments, the hanger further including a closure member to close the gap, and a wire channel configured to receive reinforcing member, the reinforcing member being a wire form, wherein the wire channel extends along at least some of the plurality of walls to wrap around at least part of at least one of the first and second support compartments. In some examples, the hanger further comprises the wire form received in the wire channel.

An advantage is a stiffer hanger with minimal material usage and weight, and optimal manufacturing tolerances. In low-load applications, the wire form may not be provided.

According to a further aspect of the invention, there is provided a hanger comprising a main part having a holding formation for holding an elongate article extending therethrough, and the main part comprising a plurality of walls defining a first support compartment and a second support compartment each for supporting an elongate item, wherein a first wall of the plurality of walls comprises a gap to allow elongate items to be received in the first and second support compartments, the hanger further including a closure member to close the gap, wherein the first and second support compartments are separated by a splitter wall of the plurality of walls, to laterally separate the elongate items, and wherein the hanger further comprises a movable spacer to separate each layer of a plurality of stacked layers of the elongate items.

An advantage of the combination of the splitter wall and the movable spacer is improved dissipation of any heat emitted from the elongate items, such as electrical cables.

The following statements refer to optional features that may individually apply to any of the preceding aspects.

The geometric centroid of the first wall may be substantially coaxial with a geometric centroid of the closure member at the closed position.

An advantage is a hanger of optimal stiffness against flexing or twisting of the hanger about multiple axes. This also minimises creep if the hanger is made from a creep-susceptible material.

Their geometric centroids may coincide with their neutral axes for bending in a first axis and/or in a second axis.

The closure member may have a minimum second moment of area having a value of at least 50% of a maximum second moment of area of the closure member. The closure member may have a round cylindrical cross-section. The closure member may have a circular cross-section.

An advantage is that the closure member contributes to the stiffness of the hanger about multiple axes.

The closure member may be a captive closure member, within a cavity of the first wall.

The first wall may have a hollow cross-section shape defining the cavity. The closure member may be slidable within the cavity. The closure member may be slidable linearly within the cavity. The closure member may be slidable coaxially with the first wall.

Advantages are that the first wall contributes to stiffness of the hanger due to having a hollow and therefore three-dimensional cross-section shape, and that the cavity protects the closure member from damage or from falling off.

The closure member may be slidable in a first direction from the open position to the closed position. The first direction may be substantially parallel to the first wall. The closure member may be slidable in a second direction from the closed position to the open position, opposite the first direction.

An advantage of sliding as opposed to pivoting is that a sliding bolt is an easier assembly component.

The closure member at the closed position may be rotatable from an unlocked orientation to a locked orientation. The closure member at the closed position may be rotatable from the locked orientation to the unlocked orientation. The closure member may define a bolt latch.

A protrusion such as a pin may be attached to the closure member to enable a user to manipulate the closure member. The first wall may comprise a slotted channel through which the protrusion protrudes and along which the protrusion is slidable. The slotted channel may have a length corresponding to a distance between the open position and the closed position of the closure member. The slotted channel may comprise a locking detent to enable the protrusion to enter the locking detent as the closure member is rotated from the unlocked orientation to the locked orientation.

The pin may be attached to the closure member by a self-locking push-fit joint. The self-locking push-fit joint may be a snap fit joint. An advantage is ease of assembly.

The first wall may be a first wall portion of a side wall of the hanger. The side wall may further comprise a second wall portion separated from the first wall portion by the gap. The second wall portion may be substantially coaxial with the first wall portion. The closure member may be movably secured to the first wall portion. The closure member may be movable into engagement with the second wall portion. The second wall portion may comprise a hole facing the gap, into which the closure member can slide.

The plurality of walls may comprise a lower wall, an upper wall, a first side wall connecting the lower wall to the upper wall, and a second side wall opposite the first side wall and connecting the lower wall to the upper wall.

The first side wall may comprise the gap.

An advantage of the gap being in a side wall is that the hanger can have a lower height, and space above the hanger is not required. If the gate was top-fed, the hanger would be taller and would require space above it. A further advantage is that the closure member will open under gravity, or close under gravity depending on the orientation of the closure member.

The hanger may comprise a plurality of the support compartments.

At least two of the plurality of support compartments may each be accessed from the gap. Alternatively, each one of the support compartments may be accessed from a different gap.

The plurality of walls may comprise a splitter wall between a pair of the plurality of support compartments. The splitter wall may divide the plurality of support compartments into the pair of support compartments.

An advantage of the splitter wall is enabling lateral spacing of the elongate items. This can help with dissipation of any heat emitted from the elongate items, such as electrical cables.

The splitter wall may extend in an upright orientation towards the upper wall. The splitter wall may extend from the lower wall. The splitter wall may extend in a substantially parallel direction to the first and second side walls.

The splitter wall may be separated from the upper wall by an inner gap. The inner gap may enable the elongate article inserted through the gap to be received into any of the first and second support compartments.

The first side wall may extend discontinuously from the lower wall to the upper wall to define the gap. The second side wall may extend continuously from the lower wall to the upper wall. The upper wall may extend continuously from the first side wall to the second side wall.

An advantage is improved stiffness because both support compartments can be accessed through the same gap, without the other side wall or upper wall needing to have a gap and corresponding additional closure member. Since only one closure member is provided, a further benefit is reduced materials and a reduced number of parts.

The hanger may comprise a plurality of the splitter walls.

The splitter wall may be centrally located along the lower wall.

The splitter wall may be centrally located between the first and second side walls. The splitter wall may be beneath a centre of gravity of the hanger.

Alternatively, the hanger may comprise a central wall connecting the lower wall to the upper wall. The central wall may be located in a central region between the first and second side walls. The central wall may extend in a substantially parallel direction to the first and second side walls.

Where splitter walls are also provided, the central wall may be between the splitter walls. The central wall may extend in a substantially parallel direction to the splitter walls. The central wall and the plurality of splitter walls may collectively define at least four support compartments.

The hanger may comprise a channel configured to receive a reinforcing member, and/or the hanger may comprise a reinforcing member. The plurality of walls may comprise the channel.

An advantage of the reinforcing member is further increased stiffness and creep protection.

The reinforcing member may comprise a wire form. The wire form may wrap around at least part of the support compartment. Where a splitter wall is provided, the wire form may wrap around at least part of the pair of support compartments defined by the splitter wall.

Advantages of a wire form compared to a reinforcing plate are that less material is used and the hanger weighs less. In addition, creating a wire form does not generate waste material, unlike subtractive manufacturing techniques. Further still, the wire form does not have to be formed with tight tolerances due to its pliability.

The wire form may be shaped to extend along at least some of the plurality of walls. The wire form may be shaped to extend continuously from the upper wall to the lower wall. The wire form may be shaped to extend along the upper wall, then from the upper wall to the lower wall, and then along the lower wall. The wire form may be shaped to extend along the upper wall, then from the upper wall to the central wall, along the central wall, then from the central wall to the lower wall, and then along the lower wall. The wire form may be C-shaped.

The channel may be in the form of a wire channel shaped and sized to receive the wire form. The wire channel may be an open channel enabling drop-in assembly of the wire form.

An advantage of a drop-in wire channel (rather than overmoulding) is that in low-load applications, the hanger can be deployed without the wire form or the wire form can be removed.

At least part of the wire channel may be defined between a wall flange and a parallel rib. At least part of the wire channel may be defined between a pair of parallel ribs extending parallel to and between a pair of wall flanges.

An advantage is that the stiffness is increased without the ribs interfering with the wire form.

The hanger may comprise one or more wire retainers to secure the wire form in the wire channel.

The wire channel may be shaped to extend continuously from the upper wall to the lower wall. The wire channel may be shaped to extend along the upper wall, then from the upper wall to the central wall, along the central wall, then from the central wall to the lower wall, and then along the lower wall. The wire channel may be C-shaped.

The main part of the hanger may define an access passage to allow access for the elongate article to the holding formation. The access passage may extend from the holding formation of said hanger to an edge of the main part.

The hanger may have a pair of the lower walls, each one for a different subset of one or more support compartments. The access passage may be defined between the lower walls. The lower walls may define an opening therebetween. The access passage may be a channel extending from the opening to the holding formation.

A pair of the central walls may extend from the lower walls. The central walls may extend from the lower walls at the opening. The opening may be defined between the central walls. The access passage may be defined between the central walls.

The central walls may extend from the lower walls to the upper wall. Where the hanger defines a plurality of support compartments, different support compartments may be arranged to opposite sides of the pair of central walls.

Where the hanger defines a plurality of support compartments, the closure member may comprise a first channel configured to receive a first reinforcing member to reinforce the first support compartment, and a second channel configured to receive a second reinforcing member to reinforce the second support compartment. Additionally, or alternatively, the hanger may comprise a first reinforcing member to reinforce the first support compartment, and a second reinforcing member to reinforce the second support compartment.

The first reinforcing member may comprise a first wire form. The first wire form may wrap around at least part of a first subset of the plurality of support compartments. The second reinforcing member may comprise a second wire form. The second wire form may wrap around at least part of a second different subset of the plurality of support compartments.

The first wire channel/first wire form may be shaped to extend along the upper wall, then to a first one of the pair of central walls, along the first central wall, then from the first central wall to a first of the pair of lower walls, and then along the first lower wall. The second wire channel/second wire form may be shaped to extend along the upper wall, then to a second one of the pair of central walls, along the second central wall, then from the second central wall to the second of the pair of lower walls, and then along the second lower wall. The first and second wire channels/wire forms may define oppositely-facing C shapes.

The hanger can further comprise a movable spacer to separate each layer of a plurality of stacked layers of elongate items. An advantage of the spacer is to help with dissipation of any heat emitted from the elongate items, such as electrical cables. The spacer and splitter wall may synergistically assist with heat dissipation.

The spacer may be retrofittable. The spacer may be slidable within the support compartment. The spacer may be slidable up and down within the support compartment. The spacer can connect to the hanger via any a sliding means (slider). The sliding means can comprise a dovetail slider. A plurality of the spacers may be inserted if there are three or more layers of elongate items.

The elongate item may be a cable, such as an electric cable or a data cable, strand, wire, wire rope, or the like. The embodiments of the invention described herein may be suitable for use in solar farms, but may be used in other industrial situations.

The embodiments of the invention described herein may be suitable for use with an elongate article in the form of a catenary wire.

The holding formation may define a recess having an open end for receiving the elongate article into the recess. The holding formation may comprise a detent member for securing the elongate article in the holding formation. Alternatively, another appropriate clamping member may be used than a detent member.

The detent member may be provided within the recess. The detent member may allow the holding formation to effect a snap fit over the elongate article to secure the hanger to the elongate article.

The main part may be formed of a polymeric material, such as an industrial plastics material.

The recess may have a securing end defining a locking space in which the elongate article may be locked. The detent member may lock the elongate article in the locking space.

The detent member may be in the form of a resiliently deformable gripping member for gripping the elongate article. The detent member may comprise a resilient portion and a locking portion on the resilient portion. The locking portion may be for locking the elongate article in the holding formation. The locking portion may comprise a shoulder for engaging the elongate article to lock the elongate article to the holding formation.

The resilient portion may be deformable by the elongate article. The holding formation may define a receiving space into which the resilient portion is deformed when the elongate article is received in the holding formation.

In the embodiments described herein, the holding formation provides the advantage that the hanger can be dropped onto the elongate article and clipped in place. In addition, the detent member helps to prevent the hanger slipping along the elongate article, thereby ensuring the hanger remains in place and does not move. The detent member also acts as a bonding interface between the elongate article and hanger.

The holding formation may be defined above the centre of gravity of the main part.

The hanger may comprise a frame. The plurality of walls may define the frame. Said frame may provide the edge of the main part.

Each support compartment may receive one or more of the elongate items, in use. Each support compartment may be defined between a respective one of the central walls and the side wall adjacent thereto.

### BRIEF DESCRIPTION OF THE DRAWINGS

For a better understanding of various examples of embodiments of the present invention reference will now be made by way of example only to the accompanying drawings in which:

FIG. 1 illustrates a perspective view of an example single-compartment hanger;

FIG. 2 illustrates a perspective view of an example multi-compartment hanger;

FIG. 3 illustrates a frontal view of the multi-compartment hanger of FIG. 2;

FIG. 4 illustrates a detail view of a holding formation;

FIG. 5 illustrates a perspective view of another example multi-compartment hanger;

FIG. 6 illustrates the closure member in its open position;

FIG. 7 illustrates how the pin can be attached to the closure member;

FIG. 8 illustrates a cross-section shape of the pin; and

FIG. 9 illustrates a cross-section view of a sliding means for a spacer.

### DETAILED DESCRIPTION OF VARIOUS EMBODIMENTS OF THE INVENTION

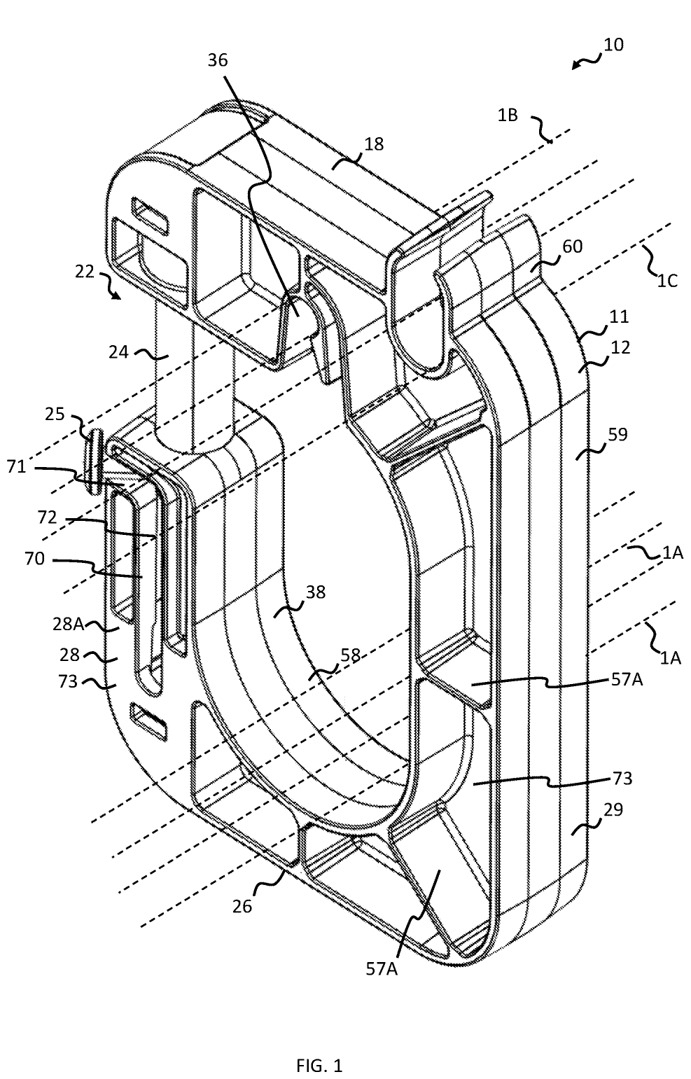

FIG. 1 of the drawings shows a hanger 10 having an interior compartment 38 defining a supporting space for supporting elongate items in the form of cables 1A (represented schematically by broken lines in FIG. 1), such as electric cables. It will be appreciated that the elongate items may be other forms of elongate items, such as wires, wire ropes, pipes or the like.

The hanger 10 comprises a body 11. The body 11 comprises a main part 12. The body 11 further includes a holding formation 36 for holding an elongate article 1B extending therethrough, in the form of an elongate support article. The elongate article 1B is represented graphically by broken lines in FIG. 1. The securing of the hanger 10 to the elongate article 1B by the holding formation 36 reduces movement of the hanger 10 along the elongate article 1B.

The hanger 10 is particularly suitable for use in a hanger system, such as in the catenary system in a solar farm, or of an electrically powered railway. The elongate article 1B may be a messenger wire of the catenary system.

The main part 12 is in the form of a frame defined by connected elongate walls including an upper wall 18, lower wall 26, first side wall 28, and second side wall 29.

The side wall 28 has a first wall portion 28A (‘first wall’) connected to the lower wall 26 but not to the upper wall 18, to define a gap 22 for accessing the compartment 38. The hanger 10 further includes a closure member 24, in the form of a bolt latch, extending up the gap 22. The closure member 24 is affixed to the body 11 at the main part 12. Specifically, in FIG. 1, the closure member 24 is affixed to the first wall portion 28A. The upper wall 18 comprises a hole (not visible) facing the gap 22, through which the closure member 24 can slide to connect the first wall portion 28A to the upper wall 18.

The main part 12 has a holding formation 36 for holding the elongate article 1B. The holding formation 36 is provided at the upper wall 18, above the centre of gravity of the main part 12. The holding formation 36 is open to the compartment 38. Therefore, the elongate article 1B can be inserted through the gap 22 into the compartment 38 and then engaged with the holding formation 36. This enables the hanger 10 to be suspended from the elongate article 1B.

The closure member 24 includes a seat 60 for receiving a further elongate item in the form of a further cable 1C (represented schematically by broken lines in FIG. 1), for example one or more data cables. The seat 60 is in the form of a substantially U-shaped member into which the further cable 1C can be received. The seat 60 is open to an exterior side of the main part 11 so that the further cable 1C does not need to be first inserted into the compartment 38.

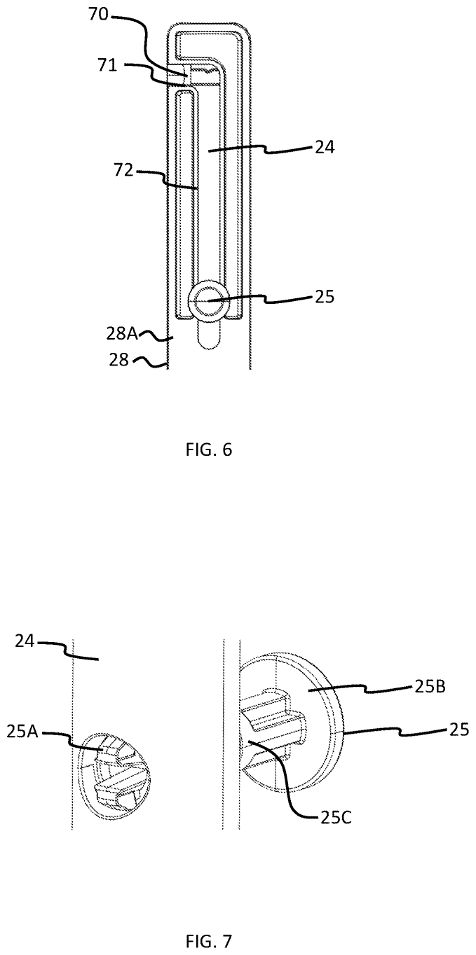

The closure member 24 is movable between an open position in which the gap 22 is open and a closed position to close the gap 22. The closed position is shown in FIGS. 1, 2, 3, and 5. The open position is shown in FIG. 6.

Regardless of the specific shape, the closure member 24 has a minimum second moment of area having a value of at least 50% or at least 60% or at least 70% of its maximum second moment of area, for uniformity of stiffness. The illustrated closure member 24 has a circular cross-section shape which satisfies this criterion.

The closure member 24 can be formed from a polymeric material. The polymeric material may be a creep resistant polymeric material such as polycarbonate. In other examples, the closure member 24 may be formed from a metallic material.

As shown in FIG. 1, the closure member 24 can be captive within an elongate cavity 70 inside the first wall portion 28A of the side wall 28. The closure member 24 can slide linearly between the open position and the closed position in either direction.

A protrusion such as a pin 25 is attached to a side of the closure member 24 in the manner of a sliding bolt latch. The pin 25 enables a user's digit to slide the closure member 24 in either direction. The pin 25 protrudes from the cavity 70 to receive a user's digit. The pin 25 protrudes through a slotted channel 72 in the first wall portion 28A of the side wall 28.

The slotted channel 72 comprises a longitudinal section extending parallel to the first wall portion 28A of the side wall 28. The slotted channel 72 comprises a lateral section extending from an end of the longitudinal section corresponding to the closed position of the closure member 24. The lateral section comprises a locking detent 71 to receive and retain the pin 25 when the pin 25 is used to rotate the closure member 24 at the closed position. When the pin 25 is received in the locking detent 71, the closure member 24 is in a locked orientation.

In the locked orientation, a formation (not visible) on the closure member 24 is angularly aligned with an interference portion (not visible) in the hole of the upper wall 18 to further secure the closure member 24 to the upper wall 18.

The closure member 24 can be sized to have a material cross-sectional area having a value of at least 50% or at least 60% of a value of a material cross-sectional area of the first wall portion 28A of the side wall 28 ignoring the locking detent 71.

When the closure member 24 is in the closed position, the closure member 24 is aligned with the side wall 28 to optimise stiffness.

The first wall portion 28A of the side wall 28 has a geometric centroid associated therewith, ignoring the locking detent 71. The geometric centroid extends along the cavity 70 and is coaxial with a corresponding geometric centroid of the closure member 24, at least while the closure member 24 is in the closed position. Even if they are not entirely coaxial, the geometric centroid of the first wall portion 28A of the side wall 28 at least overlaps a cross-section of the closure member 24. This means that the geometric centroid of the first wall portion 28A of the side wall 28 is radially closer to the geometric centroid of the closure member 24 than the perimeter of the closure member 24.

The geometric centroids of the first wall portion 28A of the side wall 28 and/or of the closure member 24 may also correspond to their neutral axes, about one or both bending planes (bending of the hanger 10 about different perpendicular axes).

Since the closure member 24 can slide linearly, it is aligned with the first wall portion 28A of the side wall 28 in the above manner regardless of whether the closure member 24 is at the closed position (whether locked or unlocked) or the open position. In other implementations (not illustrated), the closure member can be pivoted out of said alignment into the open position.

One or more, or each, wall 18, 28, 29, 26, can comprise one or more wall flanges and/or one or more ribs. FIG. 1 illustrates each wall comprising an inner wall flange 58 and an outer wall flange 59, interconnected by one or more webs 73. The inner wall flanges 58 extend in the same direction as the cables 1A. The inner wall flanges 58 define a thickness of the support compartment 38.

In FIG. 1, the first wall portion 28A is defined by a pair of wall flanges 58, 59 and pair of webs 73 defining a hollow section shape, whereas the other walls each comprise one web 73.

The inner wall flanges 58 may define the perimeter surface of the support compartment 38. The inner wall flanges 58 may comprise concave radii at corners of the frame to prevent the cables 1A being pinched and damaged in corners.

Some walls 26, 29, 18 can comprise stiffening ribs 57A. The ribs 57A of FIG. 1 stiffen the walls by extending away from the support compartment 38 to interconnect the wall flanges 58, 59.

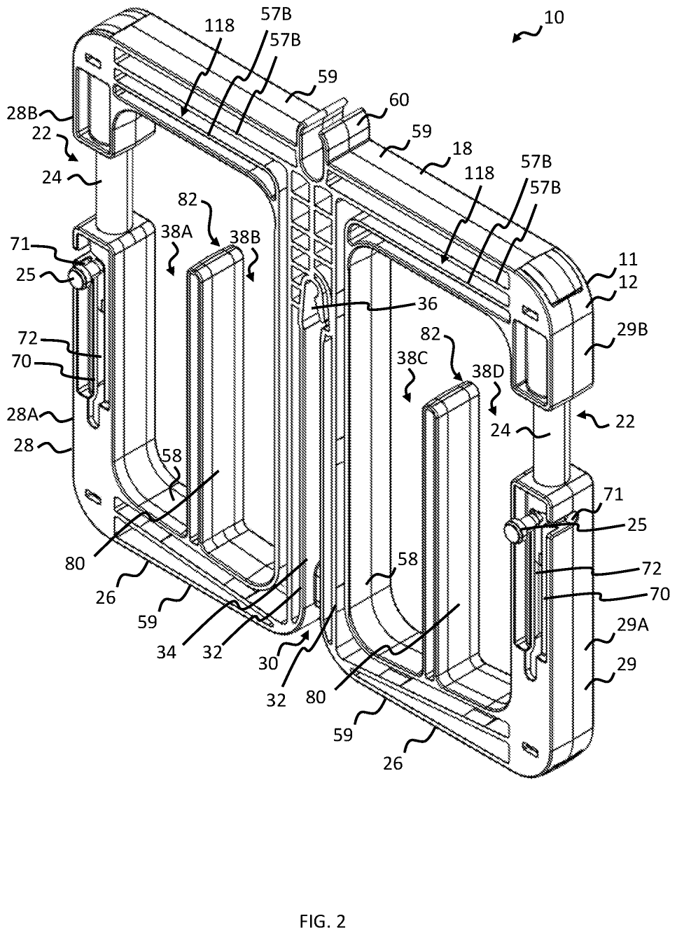

FIG. 2 shows a different hanger 10. The hanger 10 of FIG. 2 primarily differs from FIG. 1 in that multiple support compartments 38A, 38B, 38C, 38D are provided. The hanger 10 has left and right halves relative to its centre of gravity, each half comprising a subset 38A-38B and 38C-38D of the support compartments. The holding formation 36 is centrally located between the halves and is above the centre of gravity of the hanger 10.

Each half of the hanger 10 of FIG. 2 comprises an optional splitter wall 80 to divide each half into a pair of support compartments 38A-38B (left) and 38C-38D (right), i.e., four support compartments in total.

There are more support compartments in FIG. 2 than there are gaps 22 in the frame. Each splitter wall 80 is connected to a corresponding lower wall 26 and extends upwardly towards the upper wall 18 but is not connected to the upper wall 18. Therefore, an inner gap 82 is provided above each splitter wall 80, enabling an inserted cable 1A to be passed over the splitter wall 80 to be moved between the support compartments. The left pair of support compartments 38A-38B can be accessed from the gap 22 in the left side wall 28, and the right pair of support compartments 38C-38D can be accessed from a corresponding gap 22 in the right side wall 29. The purpose of each splitter wall 80 is to enable cables 1A inserted through a given gap 22 to be positioned in a laterally distributed arrangement and to remain in the laterally distributed arrangement. This can help with heat dissipation from the cables 1A if the cables 1A emit heat.

Unlike in FIG. 1, the gap 22 in FIG. 2 is optionally not at the top of the side wall 28. The side wall 28 therefore comprises a second wall portion 28B above the first wall portion 28A and separated from the first wall portion 28A by the gap 22. The closure member 24 at the closed position connects the first wall portion 28A to the second wall portion 28B. The second wall portion 28B comprises the hole and the interference portion.

The second wall portion 28B is aligned with the first wall portion 28A. The second wall portion 28B is parallel to the first wall portion 28A. The second wall portion 28B may be substantially coaxial with the first wall portion 28A. The geometric centroid of the second wall portion 28B may be substantially coaxial with that of the closure member 24 and/or the first wall portion 28A, or at least overlapping the cross-section of the closure member 24.

The right side wall 29 in FIG. 2 may have the same features as the left side wall 28 including a gap 22, closure member 24, and corresponding parts 25, 70, 71, 72.

Another difference of FIG. 2 compared to FIG. 1 is the manner in which the holding formation 36 is accessed by the elongate article 1B. A separate opening 30 is provided for the elongate article 1B, instead of the gaps 22. The main part 12 has a pair of opposed lower walls 26 forming a lower edge region. The lower walls 26 have a gap therebetween defining the opening 30.

A pair of central walls 32 extend upwardly from the lower walls 26 at the opening 30. The central walls 32 are to opposite sides of the opening 30. The central walls 32 define an access formation 34 therebetween, in the form of a passage extending from the opening 30 to the holding formation 36. The central walls 32 are substantially parallel to the side walls 28 and the splitter walls 80. The central walls 32 are connected to the upper wall 18.

The support compartments 38A-38B and 38C-38D are arranged on opposite sides of the central walls 32. The support compartments 38A-38D receive the cables 1A so that the cables 1A are supported by the hanger 10. The support compartments 38B, 38C are defined between a respective one of the central walls 32 and a respective splitter wall 80 adjacent thereto. The support compartments 38A, 38D are defined between a respective one of the splitter walls 80 and the respective side wall 28, 29 adjacent thereto. Alternatively, if splitter walls 80 are not provided, the support compartments would be defined between a respective one of the central walls 32 and a respective side wall 28, 29 adjacent thereto.

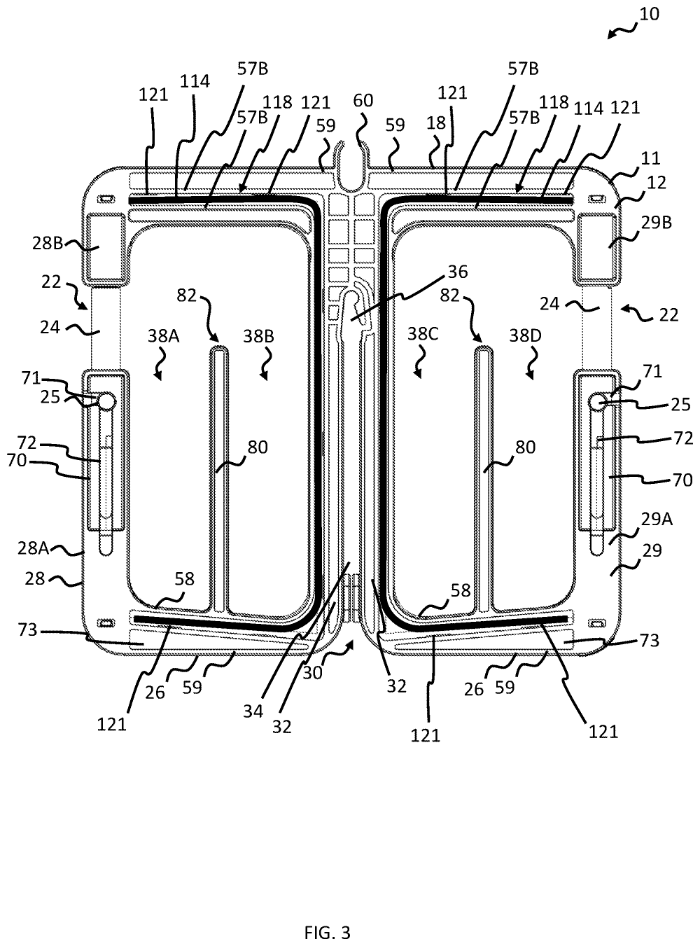

The hanger 10 of FIG. 2 may have a higher load-carrying capacity than that of FIG. 1, and therefore each half of the hanger 10 comprises a wire channel 118 configured to receive a reinforcing member in the form of a wire form 114, visible in the frontal elevation of FIG. 3.

Turning to FIG. 3, each wire form 114 is C-shaped to wrap around the corresponding support compartments. References to the shapes of the wire forms 114 are also references to the shapes of the wire channels 118.

Each wire form 114 starts proximal to a corner between the upper wall 18 and the corresponding side wall 28 or 29. The wire form 114 then extends to the junction between the upper wall 18 and the corresponding central wall 32, and comprises a bend at the junction to extend down the corresponding central wall 32. The wire form 114 then extends down to the junction between the corresponding central wall 32 and the corresponding lower wall 26, and comprises a bend at the junction to extend along the corresponding lower wall 26. The wire form 114 may terminate proximal to a corner between the corresponding lower wall 26 and the corresponding side wall 28 or 29.

Each wire channel 118 can be an open channel so that each wire form 114 can be pushed into a corresponding wire channel 118. Each wire channel 118 can comprise a plurality of wire retainers 121 to secure the corresponding wire form 114 in the wire channel 118. The wire retainers 121 can be in the form of a deformable section of material that resolves over the wire form 114, creating a retention force. Examples include snatches, snap fits, crush fits, etc.

Each wire channel 118 comprises side walls and a base. The base is the web 73 of the wall. Each side wall of the wire channel 118 is defined by any combination of: a wall flange 58 or 59; and a longitudinal rib 57B extending substantially parallel to the wall flange 58 or 59.

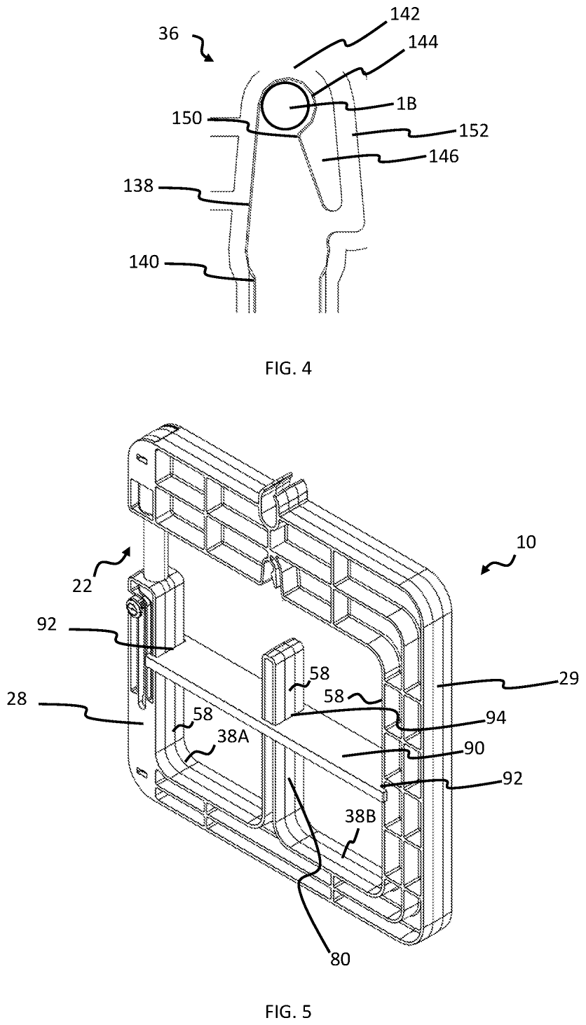

FIG. 4 illustrates a detail view of an example holding formation 36. The holding formation 36 includes a recess 138 defined by the main part 112. The recess 138 has an open end 140 for enabling the elongate article 1B to be received into the recess 138.

The recess 138 further includes a locking end 142 defining a locking space 144 in which the elongate article 1B is locked. The holding formation 36 further includes a detent member 146 for locking the elongate article 1B in the locking space 144.

The detent member 146 is in the form of a resiliently deformable gripping member for gripping the elongate article 1B. The detent member 146 comprises a locking portion 150. The locking portion 150 is in the form of a shoulder for engaging the elongate article 1B, and locking the elongate article in the locking space 144. The detent member 146 is deformed by the elongate article 1B as the elongate article 1B moves past the locking portion 150 into the locking space 144.

The holding formation 36 defines a receiving space 152 into which the detent member 146 is received when the resilient portion 148 is deformed by the elongate article 1B.

FIG. 5 illustrates a further different hanger 10. The hanger 10 of FIG. 5 is similar to that of FIG. 1 except a splitter wall 80 is provided. The illustrated splitter wall 80 is a central splitter wall. The central splitter wall 80 is aligned with the centre of gravity of the hanger 10.

FIG. 6 additionally shows a movable spacer 90 to separate each stacked layer of cables 1A. The spacer 90 can be applied to any of the embodiments, not limited to FIG. 5. The illustrated spacer 90 can comprise a bar or other structure. The spacer 90 may be user-removable from the hanger 10.

The spacer 90 can connect to the hanger 10 via any appropriate sliding means. FIG. 5 illustrates the spacer 90 comprising end notches 92, each end notch 92 to engage with a respective wall such as the side walls 28, 29. In FIG. 5, each end notch 92 is slightly wider than the flange 58 of the respective side wall 28, 29, and receives the flange 58.

Alternatively, as shown in FIG. 9, each side wall 28, 29 can comprise a rail 96 engageable with a respective end notch 92 in the spacer 90. As shown in FIG. 9, the sliding means can be in the form of a dovetail slider, to support the spacer 90.

Alternatively, the spacer 90 can comprise the rails 96 and the side walls 28, 29 may comprise the notches 92.

If the spacer 90 is double-width as shown, the spacer 90 can comprise an opening 94 through which the splitter wall 80 can extend. The opening 94 may be in a central region along the spacer 90. The spacer 90 can be slid up and down within the support compartments 38A, 38B.

The illustrated spacer 90 is retrofittable and removable. The spacer 90 can be removed by sliding the spacer 90 up to the gap 22 to disengage the sliding means. This also releases the spacer 90 from the splitter wall 80 because the gap 22 extends above the top of the splitter wall 80. A plurality of the spacers may be inserted if there are three or more layers of elongate items.

There is thus described a hanger 10 for supporting cables 1A from an elongate article 1B in the form of a messenger wire of a catenary system. The hanger 10 can carry cables 1A such as electric cables, and facilitates the mounting of the cables 1A in the hanger 10.

The hangers 10 can be more quickly installed than prior art cable holders, allowing a time saving of about 40%. This reduces the length of time the installers need to be on site, and thereby, reduces cost.

FIG. 7 illustrates a detail view of the pin 25, showing an enlarged head 25B and shaft 25C extending therefrom. FIG. 7 illustrates how the pin 25 can be attached conveniently and quickly to the closure member 24. A self-locking push-fit joint is used, in the form of a snap fit joint 25A at an end of the shaft 25C of the pin 25. The snap-fit joint 25A is implemented by barbs at the end of the shaft 25° C. of the pin, which engage with ledges inside the closure member 24 when the pin 25 is pushed in sufficiently far. It would be appreciated that the pin 25 can be attached to the closure member 24 in another way than that shown.

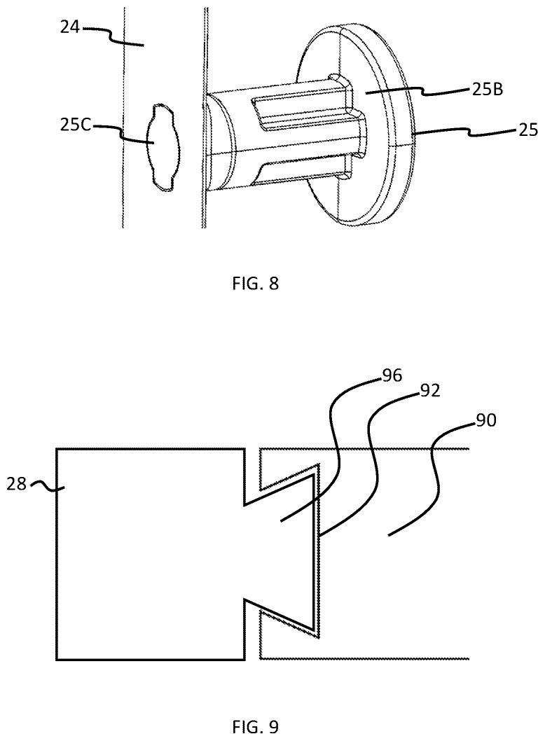

FIG. 8 illustrates a cross-section shape of the shaft 25C of the pin 25. The cross-section shape is noncircular, to prevent rotation of the pin 25.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

In the claims:

1. (canceled)

2. (canceled)

3. (canceled)

4. (canceled)

5. (canceled)

6. (canceled)

7. (canceled)

8. (canceled)

9. (canceled)

10. (canceled)

11. A hanger comprising a main part having a holding formation for holding an elongate article extending therethrough, and the main part comprising a plurality of walls defining a support compartment for supporting an elongate item, wherein a first wall of the plurality of walls defines a gap of the hanger to allow the elongate item to be received in the support compartment, the hanger further including a closure member to close the gap, the closure member being movable between an open position in which the gap is open and a closed position to close the gap, and wherein a cross-sectional geometric centroid of the first wall overlaps a cross-section of the closure member.

12. The hanger of claim 11, wherein the geometric centroid of the first wall is substantially coaxial with a geometric centroid of the closure member at the closed position.

13. The hanger of claim 11, wherein the closure member is a captive closure member, within a cavity of the first wall.

14. The hanger of claim 13, wherein the first wall has a hollow cross-section shape defining the cavity, and wherein the closure member is slidable within the cavity.

15. The hanger of any one of claim 11, wherein the closure member at the closed position is rotatable from an unlocked orientation to a locked orientation.

16. The hanger of claim 11, wherein the first wall is a first wall portion of a side wall of the hanger, wherein the side wall further comprises a second wall portion separated from the first wall portion by the gap, wherein the closure member is movably secured to the first wall portion, wherein the closure member is movable into engagement with the second wall portion, and wherein the second wall portion comprises a hole facing the gap, into which the closure member is slidable.

17. The hanger of claim 11, wherein the plurality of walls comprise a lower wall, an upper wall, a first side wall connecting the lower wall to the upper wall, and a second side wall opposite the first side wall and connecting the lower wall to the upper wall, wherein the hanger comprises a plurality of the support compartments, and wherein at least two of the plurality of support compartments are each accessible from the gap.

18. The hanger of claim 17, wherein the plurality of walls comprise a splitter wall between a pair of the plurality of support compartments, wherein the splitter wall divides the plurality of support compartments into the pair of support compartments, wherein the splitter wall extends in an upright orientation towards the upper wall, wherein the splitter wall is separated from the upper wall by an inner gap, and wherein the inner gap enables the elongate article inserted through the gap to be received into any of the pair of support compartments.

19. (canceled)

20. (canceled)

21. (canceled)

22. (canceled)

23. (canceled)

24. (canceled)

25. The hanger of claim 11, wherein the main part of the hanger defines an access passage to allow access for the elongate article to the holding formation, wherein the access passage extends from the holding formation of said hanger to an edge of the main part.

26. The hanger of any claim 11, wherein the holding formation defines a recess having an open end for receiving the elongate article into the recess, and wherein the holding formation comprises a detent member for securing the elongate article in the holding formation.

27. The hanger of claim 26, wherein the detent member is provided within the recess, and wherein the detent member allows the holding formation to effect a snap fit over the elongate article to secure the hanger to the elongate article.

28. The hanger of claim 11, wherein the holding formation is defined above a centre of gravity of the main part.

29. The hanger of claim 11, wherein the hanger comprises a frame, and wherein the plurality of walls define the frame.

30. The hanger of claim 11, wherein the closure member has a minimum second moment of area having a value of at least 50% of a maximum second moment of area of the closure member.

31. The hanger of claim 15, wherein the closure member defines a bolt latch.

32. The hanger of claim 15, wherein a protrusion is attached to the closure member to enable a user to manipulate the closure member, wherein the first wall comprises a slotted channel through which the protrusion protrudes and along which the protrusion is slidable, wherein the slotted channel has a length corresponding to a distance between the open position and the closed position of the closure member, and wherein the slotted channel comprises a locking detent to enable the protrusion to enter the locking detent as the closure member is rotated from the unlocked orientation to the locked orientation.

33. The hanger of claim 11, wherein the first wall is a first wall portion of a side wall of the hanger.

34. The hanger of claim 33, wherein the first wall portion is defined by a pair of wall flanges and pair of webs defining the hollow cross-section shape.

35. The hanger of claim 33, wherein in a locked orientation, a formation on the closure member is angularly aligned with an interference portion in a hole to further secure the closure member.

36. The hanger of claim 11, wherein the closure member is a captive closure member, within a cavity of the first wall, wherein the first wall has a hollow cross-section shape defining the cavity, and wherein the holding formation defines a recess having an open end for receiving the elongate article into the recess.
